(19) United States
(12) Patent Application Publication
(10) Pub. No.: US 2002/0079842 A1
(43) Pub. Date: Jun. 27, 2002

(54) Short-arc lamp with extended service life

(76) Inventors: Dietmar Ehrlichmann, Berlin (DE); Andreas Lochschmidt, Jettingen-Scheppach (DE)

Correspondence Address: Osram-Sylvania Inc., Attn: William E. Meyer, 100 Endicott Street, Danvers, MA, 01923, US

(21) Appl. No.: 09/910,791

(22) Filed: Jul. 24, 2001

(30) Foreign Application Priority Data
Jul. 28, 2000 (DE) 10036941.3

(51) Int. Cl. H01J 17/20

(52) U.S. Cl. 313/639

(57) ABSTRACT

High-pressure discharge lamp having two electrodes inside a discharge vessel which is filled with mercury and/or noble gas, the electrode comprising a shank and a head which is fitted thereto, at least the head of an electrode being at least partially covered with a rhenium-containing layer

### TECHNICAL FIELD

The invention is based on a short-arc lamp in accordance with the preamble of claim 1. It involves in particular mercury discharge lamps or xenon discharge lamps with a high-pressure fill.

### PRIOR ART

The document US-A 6,060,829 has already disclosed a metal halide lamp for the electrode of which a shank made from tungsten which is coated with rhenium on its surface is used.

WO 00/08672 has disclosed an electrode for a high-pressure discharge lamp which uses a dendritic layer of rhenium or other high-melting metals. The term dendritic is understood as meaning a nanostructure which is formed by a large number of acicular growths on the otherwise smooth surface. The surface of a dendritic layer of this type appears dark gray to black and reaches an emission coefficient of over 0.8. As a result, the operating temperatures at an anode plateau can be reduced by up to 200 K compared to uncoated anodes. A drawback of dendritic layers of this type is the high production outlay and the associated high costs. It is very expensive to apply dendritic coatings by means of the CVD or PVD technique. Furthermore, burning time tests using highly loaded lamps with anode coatings of this type have shown that even the dendritic acicular structures lose their initial shape over the course of the service life and as a result the anode loses its good original emissivity.

### EXPLANATION OF THE INVENTION

It is an object of the present invention to provide a short-arc lamp as described in the preamble of claim 1 which has a long service life and a low tendency to blackening.

This object is achieved by the characterizing features of claim 1. Particularly advantageous configurations are given in the dependent claims.

According to the invention, the head of the electrode is provided with a smooth coating of rhenium which increases the emission.

On account of the high electrode temperatures in short-arc lamps, electrode material is vaporized at the electrode tips and is deposited on the inside of the lamp bulb, thus leading to blackening of the bulb. This blackening inevitably reduces the light flux.

Particularly in the field of photolithography for the production of semiconductors, a reduction in light flux on account of prolonged illumination times leads to lengthened production times and, in extremis, may require the lamp to be changed prematurely.

In general, the vapor pressure of any given substance rises exponentially as the temperature increases. This is also the case with the electrode material tungsten. Even a fall in the electrode tip temperatures of only 100° C. represents a significant reduction in the vapor pressure. As a result, the abrasion of material on the electrode tips is significantly reduced, and therefore the bulb blackening is also reduced. A fall in temperature of this nature can be achieved by an emission-increasing coating of the electrode.

Various material specimens of sintering layers were tested in numerous tests. These tests found that rhenium was a suitable material for sintering layers, avoiding the drawbacks of previous solutions:

Rhenium exhibits no decomposition with respect to metal carbides, in particular TaC.

Rhenium has a higher emissivity than tungsten, so that even smooth surfaces emit more strongly. Porous rhenium sintering layers remain active even when they are sintered together to form a smooth surface on account of high operating temperatures.

A rhenium sintering layer is inexpensive to apply compared to the production of dendritic structures.

Therefore, the useful range of this inexpensive rhenium coating extends to a higher temperature range.

Temperature measurements carried out on anodes have shown that the operating temperatures in lamps in the immediate vicinity of the plateau of the anodes with rhenium sintering layers are 90 K lower than with anodes of the same structure with tungsten sintering layers (cf. graph 1). In the case of the less favorable tantalum carbide layers, temperature differences of even up to 140 K compared to rhenium were measured.

The irradiated power of a thermal radiator is described by the Stefan-Boltzmann law:

L=ε*σ*T⁴

where σ=5.67* 10⁻⁸ W m⁻² K⁻⁴,i.e. the Stefan-Boltzmann constant. The emission coefficient ε describes the deviation of a thermal radiator (0<ε<1) from an ideal black-body radiator (ε=1).

The radiation power of a thermal radiator increases the higher the temperature becomes. At high temperatures, a higher emission coefficient leads to significantly stronger emission of radiation.

Conversely, this law states that with a higher emissivity a defined quantity of heat can be emitted at a lower temperature in the form of thermal radiation.

The power fed to the anode is substantially attributable to the electrons coming into contact with the plateau region. The diameter of the anode in the immediate vicinity of the tip is of crucial importance for the heating of the anode. Experience has shown that the cross-sectional area at a distance of 2 mm from the tip is a good starting point for recording the current load of the anode tip.

The maximum temperature of the anode tip is recorded very well by the following relationship:

T=253*³√P/√0.1R (I)

where P represents the power supplied to the anode. This power substantially comprises the input work of the electrons and the anode drop voltage: I*5.5 V.

R is the radius of the anode in mm at a distance of 2 mm from the tip.

Lamps with an anode tip temperature of over 2300 K have a tendency toward rapid sintering of the porous tungsten coating.

It is particularly at these temperatures that the benefit of rhenium comes to bear: on account of its higher emission coefficient, the anode itself with a smooth rhenium layer emits more heat. The application of a porous rhenium layer is nevertheless advantageous, since it leads to an additional increase in emission at lower temperatures.

Anode tip temperatures of over 2300 K are reached, according to equation (I), if the anode radius falls below a critical value: R<10(253/2300)² (I*5.5)^{2/3}.

The improved cooling action of a rhenium sintering layer was also verified when the lamp was operated. The degradation of lamps with anodes with rhenium sintering layers was lower than with tungsten sintering layers. An example shown is a mercury short-arc lamp with a power of 3400 W. The current of this lamp is 148 A. The anode of this lamp has a diameter of 7 mm at a distance of 2 mm behind the tip. The light flux loss of the lamp with the rhenium coating was measured at 8% after 1500 h, while a lamp of an identical structure with a tungsten sintering layer was degraded by 14% (cf. FIG. 4b).

For cost reasons, tungsten or another high-melting metal may be added to the rhenium applied, although this will mean that the benefit compared to pure rhenium will decrease.

The higher the maximum temperature of use of this coating, the more effectively it can be employed. The reason for this is the fact that the heat emission of the electrode surface is proportional to the fourth power of the temperature. Therefore, the hottest regions of an electrode contribute disproportionately to the overall heat emission. It is therefore particularly effective to coat regions of this type.

The invention relates in particular to mercury short-arc lamps and noble gas high-pressure lamps, in particular xenon high-pressure lamps, having two electrodes which are spaced apart from one another. At least one electrode comprises a shank and a head which is fitted thereto. At least the head of an electrode is partially or completely covered with a rhenium-containing layer. The rhenium content in the layer should be at least 30% by weight, so that the specific effect of the rhenium still comes to bear. The invention proves particularly effective in combination with lamps with a high current load, preferably more than 60 A. In lamps of this type, it is predominantly the anode which is subjected to high thermal loads from the impinging electrons and therefore requires this layer. The electrode-to-electrode distance is preferably between 2 and 10 mm.

The layer thickness of the rhenium-containing layer is between 1 and 1000 μm, and the efficiency is preferably most pronounced at a layer thickness of over 10 μm. Above a layer thickness of 200 μm there may be problems with adhesion of the layer, in particular temperature interaction. The powder can be processed best at a mean grain size of between 1 and 20 μm, in particular 4 to 6 μm. It is thus possible to apply the layers in a manner known per se, by means of dipping or brushing (in the case of a high layer thickness) or also by means of plasma-spraying processes or CVD (in the case of a small layer thickness).

At its tip, where the temperature load is highest, the head of the electrode may be partially free of the rhenium-containing layer. Preferably, a region at the tip of the electrode head is free of the rhenium-containing layer, in particular the arc attachment surface on the end side of the electrode (particularly in the case of a straight end face, cf. FIG. 2) and at most up to a distance of 2 mm from the tip in the axial direction, for example in the case of a rounded arc attachment surface.

Since the efficiency of the coating decreases with the temperature load to which it is exposed, it will be understood that the rear end of the electrode head does not necessarily have to be coated. This applies in particular for a region forming at least 20% of the axial length at the end of the electrode head.

### FIGURES

The invention is to be explained in more detail below with reference to a number of exemplary embodiments. In the drawing:

FIG. 1 shows a short-arc lamp, in section;

FIG. 2 shows an exemplary embodiment of an electrode;

FIG. 3 shows a further exemplary embodiment of an electrode;

FIG. 4 shows a comparison of the temperature load (4a) and the burning time performance (4b) between a rhenium-coated electrode and a tungsten-coated electrode.

### DESCRIPTION OF THE DRAWINGS

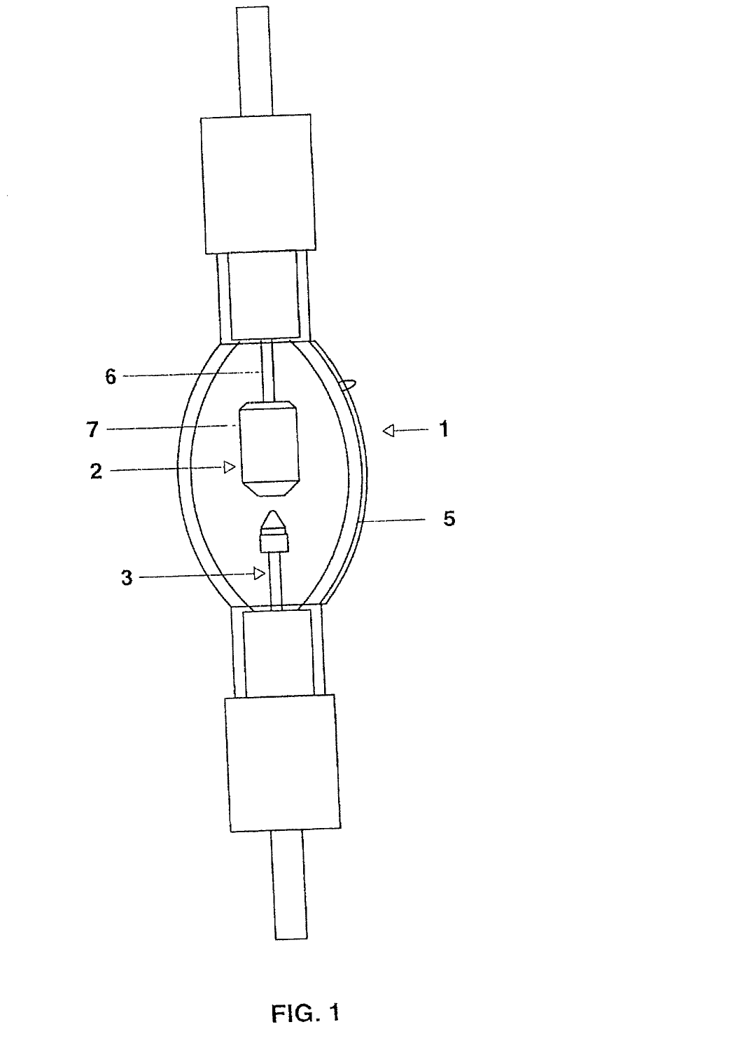

FIG. 1 diagrammatically depicts a mercury short-arc lamp (1). A discharge vessel 5, which is closed on two sides, contains an anode (2) and, opposite this, a cathode (3). The distance between the electrodes is 4.5 mm. The lamp is operated with a power of 3400 W at a current of 148 A. The discharge vessel is filled with 1.4 bar xenon and 2.5 mg of mercury per cm³. The anode comprises a cylindrical shank 6 and a solid cylindrical head 7 which is fitted thereto.

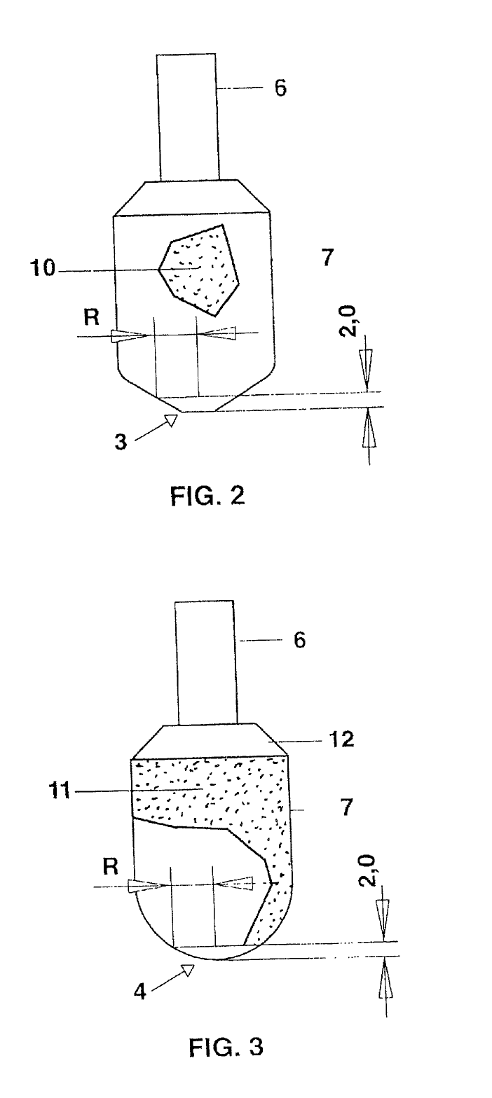

FIG. 2 shows an anode head 7 with a conical tip (3), and FIG. 3 shows a head 7 with a curved tip (4). To calculate the temperature, the anode load at a distance of 2 mm from the tip (3; 4) is crucial. The radius at that point is denoted by R in FIGS. 2 and 3. In FIG. 2, the anode head 7 is completely coated with rhenium (10), with the exception of the discharge-side end face. For reasons of clarity, the layer of rhenium is only partially illustrated. In FIG. 3, the anode head is partially coated with rhenium; specifically, the layer 11 begins at a distance of 2 mm from the tip and ends at the transitional edge to the beveled end piece 12 of the head.

In both exemplary embodiments, the rhenium layer is 50 μm thick, a particle diameter of 5 μm being selected as the mean grain size.

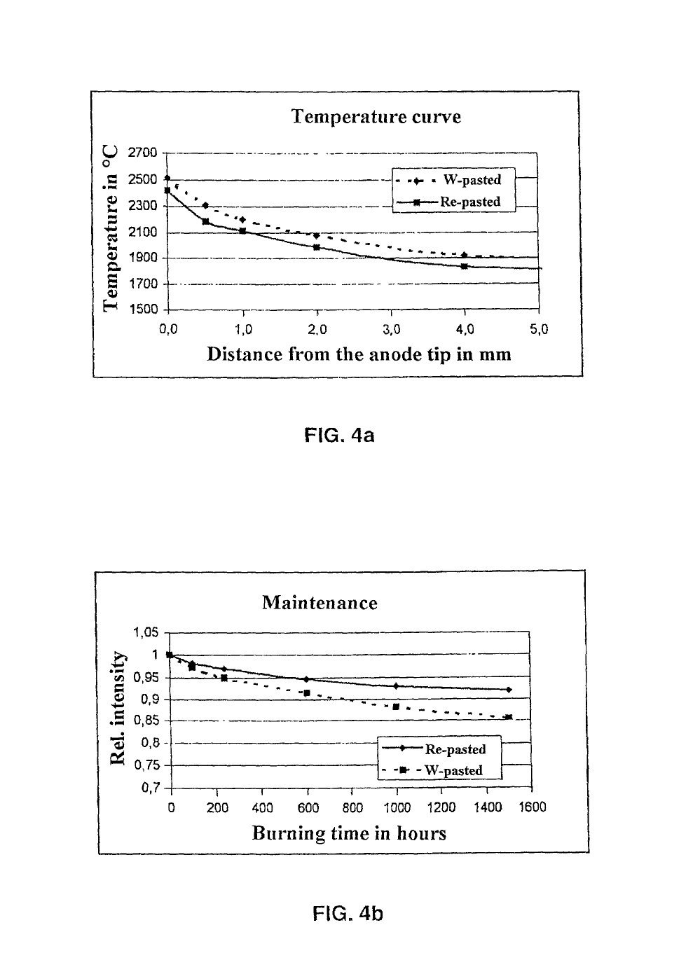

FIG. 4a shows a comparison of the operating temperatures of two identical anodes at a distance of up to 4 mm from the anode tip. The comparison between the anode coated with rhenium and an anode coated with tungsten shows the lower temperature load when using rhenium. FIG. 4b shows a comparison of the maintenance of two identical anodes. It shows the fall in light flux of the two lamps over a burning time of 1500 hours. In the version coated with rhenium, the fall is significantly lower.

1. A short-arc high-pressure discharge lamp having two electrodes, which are spaced apart from one another, inside a discharge vessel which is filled with mercury and/or noble gas, at least a first electrode comprising a shank and a head which is fitted thereto, wherein at least the head of the first electrode is at least partially covered with a rhenium-containing layer.

2. The short-arc lamp as claimed in claim 1, wherein the noble gas is xenon.

3. The short-arc lamp as claimed in claim 1, wherein the rhenium content of the layer is at least 30% by weight.

4. The short-arc lamp as claimed in claim 1, wherein the lamp is a DC lamp, of which the first, coated electrode is the anode, the anode radius R (in mm) at a distance of 2 mm from the anode tip satisfying the following condition:
R<10(253/2300)²(I*5.5)^{2/3}, where I is the current (in A).

5. The short-arc lamp as claimed in claim 1, wherein the rhenium-containing layer on the first electrode has a layer thickness of between 1 and 1000 μm, preferably 10 to 200 μm.

6. The short-arc lamp as claimed in claim 1, wherein the lamp current is greater than 60 A.

7. The short-arc lamp as claimed in claim 1, wherein the electrode-to-electrode distance of the cold lamp is between 2 and 10 mm.

8. The short-arc lamp as claimed in claim 1, wherein the rhenium-containing layer on the first electrode has a mean grain size of between 1 and 20 μm, preferably 4 to 6 μm.

9. The short-arc lamp as claimed in claim 1, wherein a region on the tip of the electrode head is free of the rhenium-containing layer, in particular the arc attachment surface and at most up to a distance of 2 mm from the tip in the axial direction.

10. The short-arc lamp as claimed in claim 1, wherein a region at the rear end of the electrode head is free of the rhenium-containing layer, in particular a region forming at least 20% of the length of the electrode head.
